(19) United States
(12) Patent Application Publication
(10) Pub. No.: US 2001/0030427 A1
(43) Pub. Date: Oct. 18, 2001

(54) Control handle for a lock

(76) Inventor: Jan de Vries, Hilversum (NL)

Correspondence Address: Greenberg Traurig, LLP, 885 Third Avenue, New York, NY, 10022-4834, US

(21) Appl. No.: 09/835,469

(22) Filed: Apr. 16, 2001

(30) Foreign Application Priority Data
Apr. 18, 2000 (NL) 1014971

(51) Int. Cl. E05C 1/12

(52) U.S. Cl. 292/169

(57) ABSTRACT

A control handle for a lock for doors or windows which is unlocked by a rotating movement of an angular pin, onto which a handle—with a corresponding cavity in its body—is pushed and keyed in or fixed.

In order to make the door handle “childproof and animal-proof” a connecting piece is present for transmission of force from the handle to the angular bar, which connecting piece is provided with a first control element. The handle is provided with a movable second control element, which can interact with the first control element after being moved by a button which is operable from the outside, but which under spring action is normally in a non-operational state. All this is realized such that the handle is normally non-operational and is rendered operational by simultaneously moving the button and turning the handle.

### FIELD OF THE INVENTION

The invention relates to a control handle for a lock, intended for doors, windows and the like of the type in which the lock is unlocked by a rotating movement of an angular pin, onto which a handle—provided with a corresponding angular cavity in its body—is pushed and keyed in or fixed by means of a securing bolt.

### BACKGROUND OF THE INVENTION

Small children are sometimes able to open doors when for various reasons they are not allowed to do so by their parents. Examples of such instances are doors of cellars and rooms containing substances that are hazardous for children, sometimes back doors that lead outside. The same type of problem exists, of course, in the case of some windows and shutters. A similar problem arises by the fact that some pets are also able to jump up to the handle and open the door in this way. In the case of children and cats it sometimes helps if the handle is set in a position rotated a quarter turn on the angular pin, so that it points upwards. Apart from the fact that this again is quite awkward for adults, there are dogs that even then are able to turn the handle. In short, there is a need for a childproof and animal-proof door and window handle.

### OBJECT OF THE INVENTION

The object of the invention is to provide such a childproof and animal-proof control handle for a lock of the type mentioned above.

### SUMMARY OF THE INVENTION

According to the invention in the control handle a connecting piece is present for the transmission of force from the handle to the angular bar, which connecting piece is provided with a first control element. The handle is provided with a movable second control element which can interact with the first after being moved by a button which under action of a spring is normally in a non-operational state, but which is operable from the outside.

This is realized in such a way that the handle is normally non-operational and is rendered operational by simultaneously moving the button and turning the handle as a whole.

This proposal makes use of the principle of childproofing known per se, by the fact that two movements have to be carried out simultaneously. Very small children are unable to do this. When they have reached the stage where they can do so, they have also become old enough to deal independently with the more or less hazardous situation from which they initially had to be protected. Of course, animals are totally incapable of simultaneously sliding a button on a door handle and turning the handle as a whole.

The basic idea of the invention can be achieved in a variety of ways. The preferred way is, however, to make the connecting piece a bush which fits on the angular bar and around which the body of the handle is rotatable, and which bush bears on its one end, as the first control element, a rib extending substantially transversely to the axis of the bush. Said rib can then be integral with an end closure of the abovementioned bush.

Furthermore, the second control element can be a movable, forked part, which through movement can grip around the rib in a substantially fitting manner.

The whole can be accommodated in the grip of the handle when the grip of the handle is provided with a cavity, which runs in its longitudinal direction and in which the forked part is slidably accommodated, together with a spring that keeps the slide non-operational and out of engagement with the rib acting as the first control element.

Owing to the fact that according to the invention the handle normally, i.e. when the control button is not intentionally slid, is non-operational, the action of a spring generally fitted inside locks is also unnecessary, with the result that the handle is kept in a normal, i.e. generally horizontal, position. The invention provides for this by the fact that preferably a spring is fitted between the body of the handle and a baseplate, which spring holds the handle in a normal position.

More particularly, the baseplate is then provided with a superimposed annular area around the body of the handle, in order to accommodate the abovementioned spring.

This solution can be achieved in a way that is aesthetically acceptable in all respects, as will appear from the description that follows of a preferred embodiment with reference to the appended drawings.

### BRIEF DESCRIPTION OF THE DRAWINGS

FIG. 1 shows the handle in a preferred embodiment of the invention, together with a cover plate, in the position in which the control button has been slid in order to make the handle operational again.

FIG. 2 shows diagrammatically a section through a door with lock and handle in the embodiment of FIG. 1 according to the invention.

FIG. 3 shows, disassembled, the two essential components by means of which the handle is put into or out of operation.

FIG. 4a shows a part of a baseplate, FIG. 4b being a section as indicated by the arrows BB.

FIG. 5a shows a partial view of an appurtenant cover plate, with FIG. 5b as a section as indicated by the arrows BB.

FIG. 6a shows the end part of the body of the handle, FIG. 6b being an end view as indicated by the arrow B in FIG. 6a.

FIG. 7 shows in section the combination of all components of FIGS. 4, 5 and 6, and

FIG. 8 shows the fitted state, including the springs used to hold the handle in a normal position.

### DESCRIPTION OF THE PREFERRED EMBODIMENT

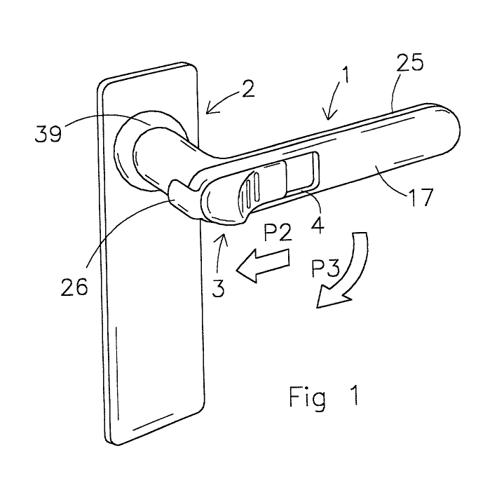

FIG. 1 shows isometrically the control handle 1 according to the invention, together with the cover plate 2. The control button is indicated by 3, being shown in the position in which it has been slid in order to make the handle 1 operational. Button 3 will slide back, under spring action in a guide cavity 4, to a rear position, in which the handle is non-operational.

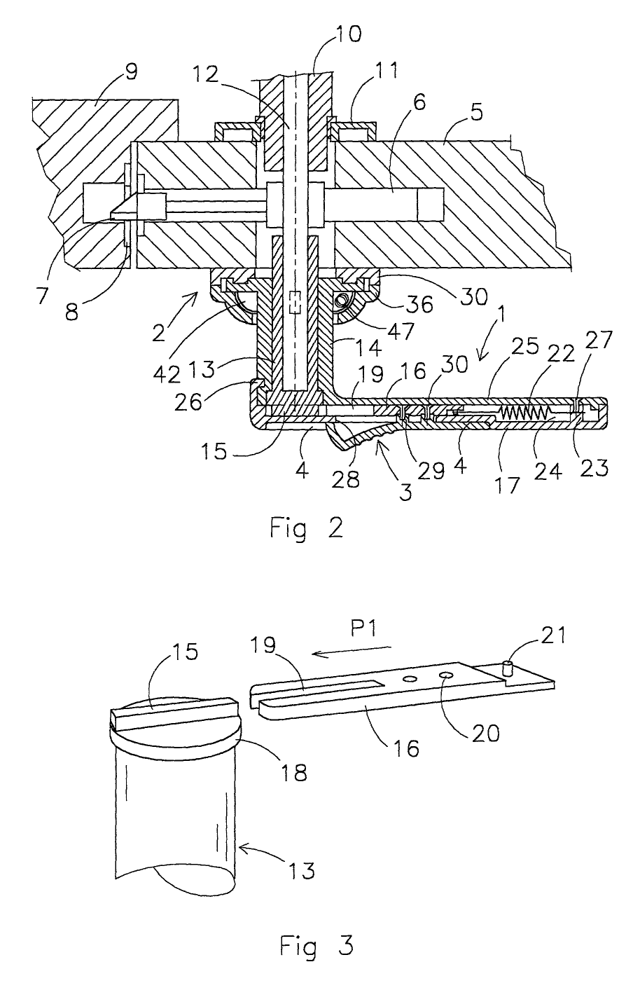

FIG. 2 is a partial section through a door 5 with a lock 6 provided therein, the catch 7 of which engages in a known manner in an aperture in a lock plate 8 in the rebate of the door frame 9.

On what will be called the back of the door 5 here, a standard handle 10 belonging to the lock 6 is fitted, with the likewise standard finish produced in the form of a cover plate 11.

The square pin 12 projecting on either side of the lock 6 for fixing of the handles is and remains a standard feature. On the front, a bush 13 is slid onto this square pin 12, which bush has a square cavity for the purpose, while it is round on the outside, so that the body 14 of handle 1 can rotate around it.

Bush 13 bears a first control element 15 in a manner to be described in greater detail below. It interacts, in a manner likewise to be described in greater detail below, with a second control element 16, which is situated in the inside of the grip 17 of the handle 1, and which is operated, in this case slid, by means of the already mentioned button 3.

The two control elements 15 and 16 are illustrated separately in FIG. 3. It can be seen from this figure that at one of its ends the bush 13 is formed with a head 18 that has a slightly larger diameter than the bush 13 itself, which bears a rib 15 that is integral therewith and is situated diametrically on top of the head 18. The rib 15 is of an elongated block shape, or in any case has parallel upright long sides. The second control element 16 is elongated and on one of its ends is provided with a slit 19 with the same cross section and substantially the same length measurement as rib 15. By being slid as indicated by arrow P1, the second control element 16 can be pushed over head 18 of bush 13, in which case slit 19 ultimately lies on either side of the rib 15 and thereby grips said rib. It can be seen in FIG. 3 that there are also two bores such as 20, by means of which the button 3 (FIG. 2) can be fixed, and a pin 21 to which a tension spring 22 can be fixed (see likewise FIG. 2), which tension spring pulls back the second control element 16, out of engagement with rib 15, into the position illustrated in FIG. 2.

The other end of spring 22 is fixed at 23 to the grip 17. For the accommodation of slide piece 16 with spring 22, the grip 17 is provided with a cavity 24. The components can be retained in the grip by the latter being shut off at the side facing the door by a closing part 25 which is integral with the body 14 of the handle. After the bush 13, the slide piece 16 and the spring 22 have been fitted, the parts 17 and 25 are connected to each other through a hooked lip 26 engaging in a groove in the body part 14, while from the back a screw 27 holds the parts together.

In the recess 4 the control button 3 is made slidable by the presence of a longitudinal groove in the grip part 17, the end of which groove is indicated in FIG. 2 by 28. Two projecting parts such as 29 can be moved through this groove, said projecting parts forming the supports for two screws such as 30, which are turned from the back through the bores 20 (see FIG. 3) in slide piece 16.

As already said, the non-operational position is shown in FIG. 2, in which position slide piece 16 is out of engagement with rib 15. The whole grip 1 can therefore be turned through the fact that the body part 14 can be freely turned about a bush 13. After the control button 3 has been slid, to the left in FIG. 2, and as indicated by the arrow P2 in FIG. 1, to the position shown in FIG. 1, rib 15 is gripped through the groove 19 in slide piece 16. This produces a connection between the handle and bush 13, which permits no further rotation, and thereafter, when the handle is turned as indicated by the arrow P3 in FIG. 1, the square pin 12 can be rotated in order to open the lock.

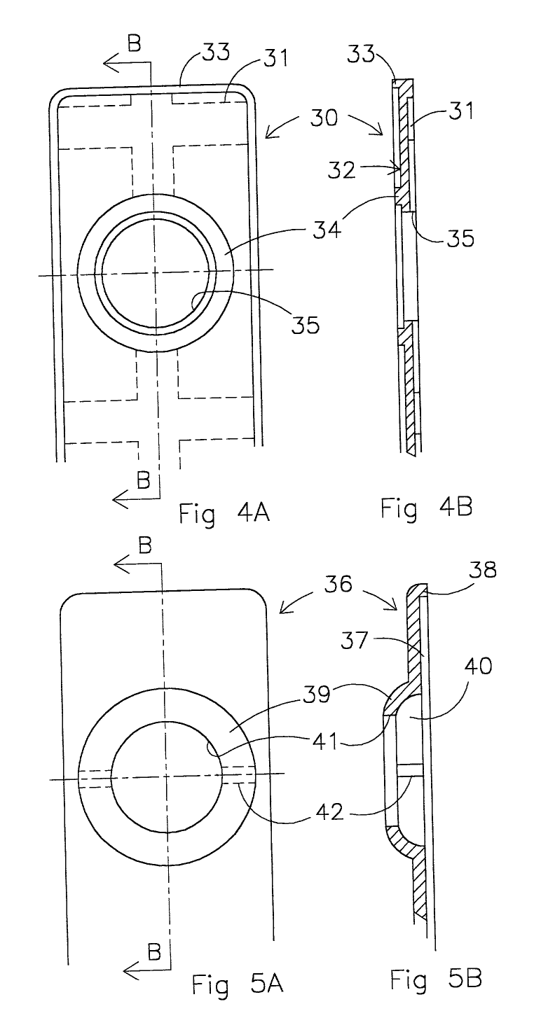

The construction is further finished in the following manner. FIG. 4a shows a front view of a baseplate 30, and FIG. 4b is a vertical midsection thereof as indicated by the arrows BB in FIG. 4a. The back of said baseplate, i.e. the side that ultimately rests against the door, is provided with a set of grooves 31 in a suitable pattern, in which it is possible to accommodate the heads of screws by means of which in the case of various door handles the cover plate such as 11 (FIG. 2) is fixed, and which project forward through the door from the back to the front of the door, where they help to fix a front cover plate that is removed to fit the handle mechanism according to the present invention. On the front of the baseplate a recess 32 can be provided over the greater part of the plate, which recess leaves the material of a peripheral edge 33 and of a centring ring 34 around the passage aperture 35 for bush 13.

A cover plate 36, shown separately in FIGS. 5a and 5b, ultimately rests on the baseplate 30. On the back of said cover plate a recess 37 is again provided, leaving clear a peripheral edge 38, which is designed to rest upon peripheral edge 33 of baseplate 30. On the front, a cavity 40 is created by providing an elevation 39 which, through the presence of a central push-through aperture 41, in its entirety acquires an annular shape that can be seen in FIG. 1. Two ribs 42 have remained at positions diametrically opposite each other in the cavity 40, said ribs being designed to act as pressure faces for springs to be fitted. It can be seen in FIG. 5a that said springs are situated in the horizontal plane through the axis, in the position in which the cover plate is to be fitted.

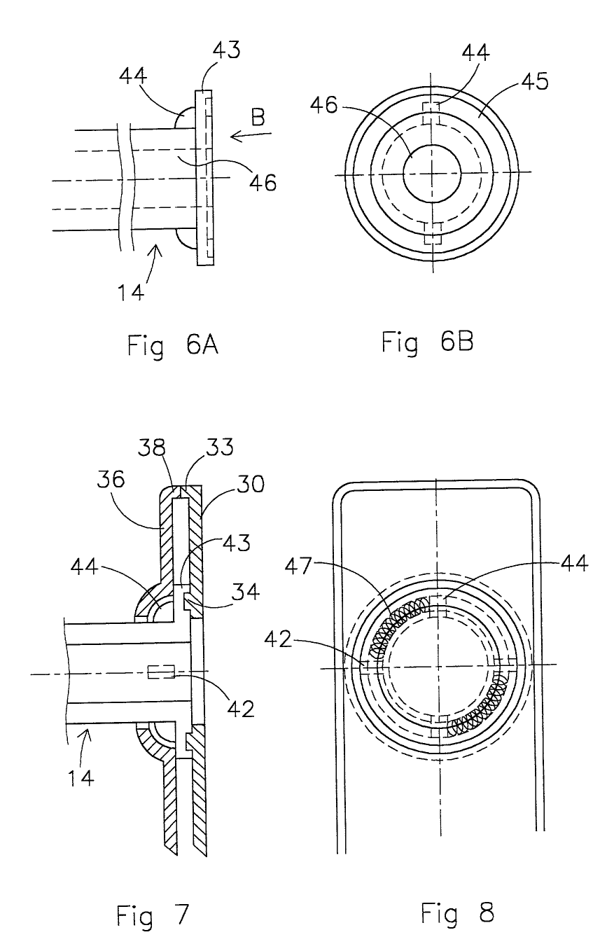

Then FIG. 6a shows the end of the body part 14 of the handle that is widened with a disc moulded on integrally. Likewise moulded on integrally are two ribs 44 which, as can be seen from FIG. 6b, are situated in a vertical plane through the axis. These are the other pressure faces for the fitting of springs.

Looking towards the end face of disc 43, as indicated by arrow B, one obtains the view of FIG. 6b. An annular groove 45 is provided on that side. Of course, the bore 46, designed for the bush 13 (see FIG. 2) to be pushed through, can also be seen. Annular groove 45 serves to retain the body part 14 of the handle in such a way that it is centred, but rotatable relative to the baseplate 2, as can be seen from FIG. 7, which shows the combination; annular groove 45 fits on annular rib 34 of the baseplate 30.

Finally, FIG. 8 shows the fitted state, in which two springs such as 47 are provided between a rib 42 on the baseplate and a rib 44 on the handle. These compression springs ensure that the handle is held normally in the horizontal position that is obtained in the case of traditional door handles through the action of a spring inside the lock; said lock spring now acts only upon the handle on the back of the door; since in the case of the handle on the front this spring action was rendered non-operational because the handle as a whole was rendered non-operational.

What is claimed is:

1. A control handle for a lock, intended for doors, windows and the like of the type in which the lock is unlocked by a rotating movement of an angular pin, onto which a handle—provided with a corresponding angular cavity in its body—is pushed and keyed in or fixed by means of a securing bolt, wherein
a connecting piece is present for the transmission of force from said handle to said angular bar, which connecting piece is provided with a first control element, ans wherein
said handle is provided with a movable second control element, which can interact with said first control element after being moved by a button which under action of a spring is normally in a non-operational state, but which is operable from the outside,
all this in such a way that said handle is normally non-operational and is rendered operational by simultaneously moving said button and turning the handle as a whole.

2. A control as in claim 1, wherein said connecting piece is a bush which fits on said angular bar and around which the body of the handle is rotatable, and which bush bears on its one end, as the said first control element, a rib extending substantially transversely to the axis of the bush.

3. A control handle as in claim 1, wherein said connecting piece is a bush which fits on said angular bar and around which the body of the handle is rotatable, and which bush bears on its one end, as the said first control element, a rib extending substantially transversely to the axis of the bush, said rib being integral with an end closure of the bush.

4. A control handle as in claim 1, wherein said connecting piece is a bush which fits on said angular bar and around which the body of the handle is rotatable, and which bush bears on its one end, as the said first control element, a rib extending substantially transversely to the axis of the bush, said rib being integral with an end closure of the bush, said second control element being a movable forked part, which through movement can grip around said rib, as the first control element, in a substantially fitting manner.

5. A control handle as in claim 1, wherein said connecting piece is a bush which fits on said angular bar and around which the body of the handle is rotatable, and which bush bears on its one end, as the said first control element, a rib extending substantially transversely to the axis of the bush, said rib being integral with an end closure of the bush, said second control element being a movable forked part, which through movement can grip around said rib, as the first control element, in a substantially fitting manner, the grip of the handle being provided with a cavity extending in the longitudinal direction of the grip, in which cavity said forked part is slidably accommodated, together with a spring that keeps said forked part non-operational and out of engagement with the rib that acts as the first control element.

6. A control handle as in claim 1, wherein said connecting piece is a bush which fits on said angular bar and around which the body of the handle is rotatable, and which bush bears on its one end, as the said first control element, a rib extending substantially transversely to the axis of the bush, said rib being integral with an end closure of the bush, said second control element being a movable forked part, which through movement can grip around said rib, as the first control element, in a substantially fitting manner, the grip of the handle being provided with a cavity extending in the longitudinal direction of the grip, in which cavity said forked part is slidably accommodated, together with a spring that keeps said forked part non-operational and out of engagement with the rib that acts as the first control element, and wherein the grip of the handle comprises a first part and a second part, said cavity, which extends in the longitudinal direction and in which the forked part and the spring are accommodated, being provided in the first part, and said cavity being shut off by the second grip part.

7. A control handle as in claim 1, wherein said connecting piece is a bush which fits on said angular bar and around which the body of the handle is rotatable, and which bush bears on its one end, as the said first control element, a rib extending substantially transversely to the axis of the bush, said rib being integral with an end closure of the bush, said second control element being a movable forked part, which through movement can grip around said rib, as the first control element, in a substantially fitting manner, the grip of the handle being provided with a cavity extending in the longitudinal direction of the grip, in which cavity said forked part is slidably accommodated, together with a spring that keeps said forked part non-operational and out of engagement with the rib that acts as the first control element, and wherein the grip of the handle comprises a first part and a second part, said cavity, which extends in the longitudinal direction and in which the forked part and the spring are accommodated, being provided in the first part, and said cavity being shut off by the second grip part, the grip being provided with a groove, connecting to said cavity, for passing through the control button on the outside of the grip.

8. A control handle as in claim 1, wherein said connecting piece is a bush which fits on said angular bar and around which the body of the handle is rotatable, and which bush bears on its one end, as the said first control element, a rib extending substantially transversely to the axis of the bush, said rib being integral with an end closure of the bush, said second control element being a movable forked part, which through movement can grip around said rib, as the first control element, in a substantially fitting manner, the grip of the handle being provided with a cavity extending in the longitudinal direction of the grip, in which cavity said forked part is slidably accommodated, together with a spring that keeps said forked part non-operational and out of engagement with the rib that acts as the first control element, and wherein the grip of the handle comprises a first part and a second part, said cavity, which extends in the longitudinal direction and in which the forked part and the spring are accommodated, being provided in the first part, and said cavity being shut off by the second grip part, the grip being provided with a groove, connecting to said cavity, for passing through the control button on the outside of the grip, the control button being movable in a recessed part (4) on the outside of the grip.

9. A control handle according to claim 1, wherein at least one spring is fitted between the body of the handle and a baseplate, which spring keeps the handle in a normal position.

10. A control handle according to claim 1, wherein at least one spring is fitted between the body of the handle and a baseplate, which spring keeps the handle in a normal position, said baseplate being provided with a superimposed annular area around the body of the handle, in order to accommodate said spring (47).
